(19) United States
(12) Patent Application Publication
(10) Pub. No.: US 2026/0312531 A1
(43) Pub. Date: Oct. 8, 2026

(54) System for Attaching a Wind Deflector to a Solar Panel

(71) Applicant: Enstall Europe B.V., Deventer (NL)

(72) Inventors: Maarten Smit, Nijverdal (NL); Machiel Gemser, Nijmegen (NL)

(21) Appl. No.: 19/476,225

(22) PCT Filed: Apr. 18, 2024
(86) PCT No.: PCT/NL2024/050202

§ 371 Date: Oct. 17, 2025

(30) Foreign Application Priority Data
Apr. 18, 2023 (NL) 2034607

(51) Int. Cl. H02S 30/10; H02S 20/23; H02S 40/40

(52) U.S. Cl. CPC H02S 30/10; H02S 20/23; H02S 40/40

(57) ABSTRACT

The invention relates to a system for attaching a wind deflector to a solar panel, in particular to a module frame of a solar panel, said system including at least one primary clamping structure and at least one secondary clamping structure. The primary and secondary clamping structures are each configured to be clampingly coupled to at least one solar panel, in particular to the module frame of the solar panel, and to be connected to at least part of at least one wind deflector.

### CROSS-REFERENCE TO RELATED APPLICATIONS

This application is the United States national phase of International Patent Application No. PCT/NL2024/050202 filed Apr. 18, 2024, and claims priority to The Netherlands Patent Application No. 2034607 filed Apr. 18, 2023, the disclosures of which are hereby incorporated by reference in their entireties.

### BACKGROUND OF THE INVENTION

### Field of the Invention

The invention relates to a system for attaching a wind deflector to a solar panel. The invention also relates to a primary clamping structure and a secondary clamping structure for use in such system.

### Description of Related Art

Wind deflectors are often used in low slope mounting solutions for solar panels. The wind deflectors provide protection for the system and panels against the wind whilst they typically still enable good ventilation. The wind deflectors are typically positioned at the open ends of the solar panel arrays, where they are connected to the solar panel mounting system. A drawback of the known wind deflector systems is that they are restricted in the number of flat mounting solar panel solutions in which they can be incorporated due to their mounting limitations.

### SUMMARY OF THE INVENTION

Hence, it is a goal of the invention to provide an improved solution for the use of wind deflectors in solar panel systems.

The invention provides thereto a system for attaching a wind deflector to a solar panel, in particular to a module frame of a solar panel, said system comprising at least one primary clamping structure, and/or at least one secondary clamping structure, wherein at least one primary clamping structure and at least one secondary clamping structure are each configured to be clampingly coupled, or clampingly connected, to at least one solar panel, in particular to the module frame of the solar panel, and to be connected to at least part of at least one wind deflector, wherein the primary clamping structure preferably comprises at least one support arm, at least one aligning member and/or at least one connector, wherein at least one support arm is connected to at least part of the aligning member and/or at least part of the connector, and wherein at least one support arm is substantially elongated and wherein a distal end of at least one support arm is configured to be connected to at least part of at least one wind deflector, and in particular wherein at least one aligning member and at least one connector are configured such that, in an assembled configuration, at least part of at least one connector encloses and/or receives at least part of the aligning member, and/or vice versa, such that at least part of the solar panel, in particular part of the module frame of the solar panel, is clampingly engaged between at least one aligning member and at least one connector.

The system according to the present invention enables attaching of a wind deflector to a solar panel, in particular to a module frame of a solar panel, in an efficient and effective manner. Since the system enables that the wind deflector can be attached directly to the solar panel, the system can be used in combination with any type of solar panel mounting system, in particular any substantially levelled and/or low slope surface solar panel mounting system. However is not limited to substantially levelled and/or low slope surface solar panel mounting systems and could be used for high slope systems for example. Conventional wind deflector systems typically require that the wind deflector(s) is/are connected to the mounting system of the solar panel(s). Due to the use of at least one primary clamping structure and at least one secondary clamping structure according to the present invention, the wind deflector(s) can be directly coupled to the solar panel(s). In particular the system according to the present invention can enable coupling of wind deflectors on the side of the solar panel that is facing the open side of a solar panel array. This can be achieved because the secondary and/or primary clamping structure can be configured to clampingly engage the open side of a solar panel, in particular the open side of a module frame of a solar panel. The (open side facing) side of a solar panel, in particular the (open side facing) side of a module frame of a solar panel, may comprise a flange or be flangeless. The substantially elongated support arm enables that part of the wind deflector can be supported and connected in an effective manner. The substantially elongated support art enables that a lower portion of the wind deflector can be supported. The primary clamping structures comprises at least two co-acting components. The mutual co-action between the aligning member and the connector enable that at least part of the solar panel can be enclosed between the aligning member and the connector such that a clamping engagement is arranged. This results in an effective and stable clamping configuration of the clamping structure, which provides sufficient support, in particular in combination with the further support of the support arm, for the wind deflector attached to the clamping structure.

Co-action between two parts of a clamping structure can be arranged in different ways. At least part of at least one connector can be configured to enclose and/or receive at least part of the aligning member. It can also be the case that at least part of the aligning member can be configured to enclose and/or receive at least part of the connector. It is also possible that the aligning member receives at least part of the connector and that the connector receives at least part of the aligning member. In such a configuration mutual rotation can be restricted. All co-action configurations ensure that at least part of the solar panel, in particular part of the module frame of the solar panel, can be clampingly engaged between at least one aligning member and at least one connector.

In an embodiment, the secondary clamping structure may be formed by a clamp, for example a commonly known clamp or a clip.

In alternative embodiments for a system for attaching a wind deflector to a solar panel, in particular to a module frame of a solar panel, the number of primary clamping structures and/or secondary clamping structures may vary. It is conceivable that the system may comprise two primary clamping structures and at least one secondary clamping structure. It is also conceivable that the system may comprise two primary clamping structures, instead of a secondary clamping structure a primary clamping structure is then used. In such an embodiment, the system can be without any secondary clamping structures. In another example, two primary clamping structures can be combined with other fixing means, such as a fixing element as a screw, for fixating the wind deflector instead of the secondary clamping structure.

It is also conceivable that the system comprises at least two secondary clamping structures without a primary clamping structure. Instead of a primary clamping structure a secondary clamping structure can be used.

It is also conceivable that the system comprises at least two primary clamping structures without a secondary clamping structure. Instead of a secondary clamping structure a primary clamping structure can be used.

On steep slope or low slope systems, where the solar panel array is positioned substantially parallel to the roofing surface, it is conceivable that the system according to the present invention may comprise multiple secondary clamping structures and/or multiple primary clamping structures.

At least one primary clamping structure is in particular configured for retaining at least part of the wind deflector. At least one secondary clamping structure is in particular configured for retaining at least a further part of the wind deflector. The primary and/or secondary clamping structures in particular have a non-constructive function with respect to the solar panel. The primary and secondary clamping structures enable connection of the wind deflector and they provide support for the wind deflector but they are not configured or suitable for providing mechanical support for the solar panel as such. The clamping structures according to the present invention in particular enable that a wind deflector can be applied without the requirement that said wind deflector is connected to the fixed world or to the solar panel mounting system. In an assembled configuration of at least one primary clamping structure, at least one secondary clamping structure and at least one wind deflector, the support arm of at least one primary clamping structure typically extends in between the wind deflector and at least part of a side of a solar panel, in particular a high side (long side) of a module frame of a solar panel. It is also conceivable that the support arm defines a triangular configuration in combination with the wind deflector and the solar panel. By high side the side running parallel to the roof (or other mounting surface) and positioned highest with respect to the roof (or other mounting surface) is meant.

At least one primary and/or secondary clamping structure is in particular configured to be connected to a (long and/or short sided) edge of a solar panel. The clamping structures are suitable for connection to any module frame of a solar panel regardless whether the module frame comprises a flange or an (flangeless) extending edge. It is conceivable that the support arm of a primary clamping structure would engage with an entire module frame and/or the flange of a side of the module frame. The system according to the present invention could also be referred to as an assembly for attaching a wind deflector to a solar panel, in particular to a module frame of a solar panel. Within the context of the invention, at least one primary or secondary clamping structure could also be referred to as a primary or secondary bracket. The system is in particular suitable for use in combination with a low slope mounting solution for solar panels.

In a preferred embodiment, at least one secondary clamping structure comprises at least one secondary aligning member and at least one secondary connector. Preferably, at least one secondary clamping structure is configured to be connected to a wind deflector, and wherein in particular the secondary aligning member is configured to be connected to a wind deflector. Preferably, at least one secondary aligning member and at least one secondary connector are configured such that in an assembled configuration, at least part of the secondary connector encloses and/or receives at least part of the secondary aligning member such that at least part of the solar panel, in particular part of the module frame of the solar panel, is clampingly engaged between the secondary aligning member and the secondary connector. It is also imaginable that at least part of the secondary aligning member encloses and/or receives at least part of the secondary connector such that at least part of the solar panel, in particular part of the module frame of the solar panel, is clampingly engaged between the secondary aligning member and the secondary connector. The secondary clamping structure provides an efficient and effective attachment of part of the wind deflector to the solar panel in a clamping manner. The secondary clamping structure can be substantially equal to part of the primary clamping structure. All embodiments as described for respectively the primary aligning member and the primary connector could also apply to the secondary aligning member and the secondary connector. In a preferred embodiment, it is imaginable that the aligning member and the connector of the primary clamping structure are the same as the secondary aligning member and the secondary connector respectively. The use of at least one secondary clamping structure enables further support of the wind deflector. This results in a more stable and reliable connection of the wind deflector to the solar panel (system).

In a preferred embodiment, at least one aligning member of the primary clamping structure comprises at least one aligning surface. At least one aligning surface can for example be configured to align at least part of the wind deflector with respect to the solar panel. It is also imaginable that at least one aligning surface is configured to align at least part of the primary clamping structure with respect to the solar panel. Alternatively and/or additionally at least one aligning surface can be configured to align the aligning member with respect to the connector and/or the support arm. In a preferred embodiment, the aligning member comprises multiple aligning surfaces. Preferably, at least two aligning surfaces are positioned at a distance from each other. It is imaginable that at least part of the aligning surface is substantially profiled. Part of the aligning surface can for example be substantially structured. It is imaginable that part of the aligning surface comprises a repeated structure, such as for example a ribbed structure. It is also imaginable that at least part of the aligning surface is substantially flat and/or smooth.

At least one connector of the primary clamping structure could comprise at least one clamping surface. The presence of at least one clamping surface could facilitate clamping in a more controlled manner. In a further preferred embodiment, at least one connector comprises at least one leg, and preferably at least two legs, wherein at least one leg comprises a clamping surface at or near its distal end. It is imaginable that at least one connector comprises at least two legs of substantially the same length. In this way, the stability of the connector during use could be optimized. However, it is also imaginable that the connector comprises at least two legs having a different length. It is imaginable that at least part of the clamping surface extend in a direction facing away from the longitudinal direction of the leg of the connector. At least part of the clamping surface can be positioned at an angle with respect to the longitudinal direction of the leg(s) of the connector. Preferably at least part of the clamping surface is positioned substantially perpendicular to the longitudinal direction of the (at least one) leg of the connector. It is imaginable that at least one aligning member comprises at least one leg, or at least two legs, wherein preferably at least one leg is substantially complementary to at least one leg of the connector. At least part of the clamping surface can be substantially flat. It is also possible that at least part of the clamping surface comprises a profile, a texture and/or a (profiled) structure. The texture of the clamping surface can for example be configured to provide a better grip between the connector and the solar panel, or the mounting frame thereof. It is imaginable that the clamping surface comprises a repeated structure, for example a ribbed structure. It is imaginable that at least part of the (profiled) structure of the clamping surface is configured to be in abutting contact with a part such as an edge of the module frame of the solar panel, preferably the open (short sided) side edge, during use. It is also imaginable that the clamping surface contributes to the adaptive character of the connector, resulting in a better clamping connection between the connector, the solar panel and the aligning member. At least part of at least one clamping surface can for example be substantially rigid. It is also imaginable that at least part of the clamping surface is substantially deformable. It is possible that at least part of the clamping surface is adaptive upon subjecting the clamping structure to an (external) force. The (external) force can for example be applied to the clamping structure through a fixing element, such as a screw.

In a further possible embodiment, it is imaginable that at least one connector comprises at least one aperture. At least one aperture can for example be configured to receive part of the aligning member. It is also possible that at least one aperture is configured to receive at least part of a fixing element. It is also possible that at least one connector comprises a receiving space for receiving at least part of a module frame of a solar panel and/or for receiving at least part of the aligning member. The receiving space can for example be configured to receive at least part of a flange of the module frame. It is imaginable that at least one connector defines a receiving space for receiving at least part of the aligning member. Such embodiment could positively contribute to efficient and reliable co-action between the connector and the aligning member. It is for example imaginable that at least part of the connector comprises a substantially U, C or V shaped configuration. It is also possible that the connector comprises at least two legs, wherein a receiving space is defined between said legs. At least two legs of the connector can be substantially parallel. It is also imaginable that at least part of the legs diverge or converge with respect to each other. At least one leg, or each leg, can be substantially flexible. It is also imaginable that at least one leg, or each leg, is substantially rigid.

It is also imaginable that at least one aligning member and at least one connector form a clamp. At least one aligning member and at least one connector can for example form a two-piece clamp. It is also imaginable that the clamp is at least partially formed by a hinge. The aligning member and the connector can be mutually connected via a hinge. It is also possible that the aligning member and the connector together function as a clamp and/or a hinge.

During use, in particular prior to fixation thereof, at least one aligning member and at least one connector are mutually movable or mutually displaceable. It is imaginable that at least one connector can be slid with respect to the aligning member. The displaceable character enables further alignment of the aligning member with respect to the connector, or vice versa, or alignment of the primary clamping structure as such. At least one connector and at least one aligning member are mutually connectable, in particular by a fixing element such as a screw. It is for example imaginable that the aligning member and/or the connector comprises an internal screw thread for receiving at least part of the screw. In case the aligning member and/or the connector comprises at least one leg, it is imaginable that at least part of the internal screw thread is provided in the leg. It is also imaginable that the aligning member and/or the connector comprises an accommodation space for accommodating at least part of a fixing element. The fixing element, preferably a screw, can be configured to mutually attach the aligning member and the connector, preferably under the interference of part of the (module frame of the) solar panel. The fixing element can be configured to provide a clamping force between the aligning member and the connector towards the solar panel which is received in between the aligning member and the connector. The system, and in particular the primary clamping structure and/or secondary clamping structure could also comprise at least one fixing element. Alternatively, it is imaginable that at least one connector and at least one aligning member are mutually connectable via a snap connection and/or a screw connector. In such embodiment, the use of at least one external fixing element can be omitted.

In a preferred embodiment, at least one aligning member comprises at least one alignment leg. At least one alignment leg is preferably configured such that it extends from the aligning member in a direction away from the wind deflector in an assembled configuration of the clamping structure. In case the aligning member comprises at least one aligning surface, it is preferred that at least one aligning surface is positioned at a distance from at least one aligning leg. However, it is also imaginable that at least one alignment leg comprises at least one aligning surface. At least one alignment leg can for example be configured to be received in at least one receiving space of the connector. At least one aligning member could also comprise at least two aligning legs. Said aligning legs can be positioned in a substantially parallel orientation. It is for example imaginable that the parallel positioned alignment legs provide alignment for at least part of the connector, for example a leg thereof, which is received between the legs of the aligning member.

It is also possible that the connector comprises at least two legs, wherein a receiving space is defined between said legs. The legs could define an insertion opening for inserting at least part of the connector.

In a preferred embodiment, at least one aligning member comprises a wall part that is configured to abut part of a solar panel, in particular part of a mounting frame of the solar panel. The wall part preferably comprises a chamfered top edge. The wall part comprising the chamfered top edge is preferably configured such that a space is present in between the top edge of the wall and the solar panel in assembled state. In an alternative embodiment the aligning member may comprise a wall including a receiving space for receiving a part of a wind deflector. For example, this can be a recessed channel in the top surface of the wall of the aligning member. The wall part is preferably configured to abut an edge of the solar panel, in particular an edge of a mounting frame of the solar panel. It is possible that the wall is substantially straight. At least part of the wall part can be provided a texture. In particular part of the wall part which is configured to abut the solar panel can be provided with a texture. The texture can provide a better grip when the wall part is clamped towards the solar panel. In case the aligning member comprises at least one leg, it is preferred that the wall part extends substantially perpendicular with respect to at least one leg. Hence, it is imaginable that at least one leg and at least one wall part of the aligning member define an L-shape. It is imaginable that at least one wall part comprises at least one aligning surface.

A least one primary clamping structure is preferably configured to be coupled to the edge on the high side, or on the flange of the edge on the high side, or long-sided edge of the solar panel, in particular the (flanged) edge of a module frame of the solar panel, by the support arm and wherein the at least one clamping structure is configured to be coupled to the (short sided) side edge of the solar panel, in particular the (flanged or non-flanged module frame of the solar panel. The long-sided edge of the solar panel, or the module frame thereof, could optionally comprise a flange. Seen the adaptive character of the system according to the present invention, the system can be used in combination with a solar panel frame which does not comprise a flange at the free side end too.

At least one support arm of the primary support structure preferably comprises at least one grip element, or multiple grip elements, for increasing grip with part of the solar panel, for example a top and/or side edge of the solar panel. In a preferred embodiment, at least one support arm comprises a clamping element for clampingly engaging at least part of a solar panel, in particular part of a module frame of the solar panel. At least one clamping element could for example comprise at least one upper flange part and/or at least one lower flange part configured to mutually enclose and/or clampingly engage part of a solar panel, in particular part of a module frame of the solar panel, more in particular part of a side flange of a module frame of the solar panel. It is also imaginable that at least one clamping element comprises at least one clamping finger. The presence of at least one clamping finger could further optimize the clamping connection between the support arm and the solar panel. The at least one clamping element preferably extends with respect to the substantially elongated part of the support arm. In an alternative embodiment, it is also imaginable that at least clamping element, if applied, form part of the aligning member instead of the support arm. Any of the described embodiments of the clamping element could also form part of the aligning member. It is also imaginable that at least one aligning member and/or at least one connector comprises at least one grip element.

At least one primary clamping structure and at least one secondary clamping structure are preferably configured to be at least partly attached to the same element of the module frame of the solar panel, in particular to the same side edge of the module frame of the solar panel. Such configuration provides a more stable alignment of the clamping structures and thus also of the wind deflector connected to said clamping structures. Typically at least one secondary clamping structure is positioned at a distance from at least one primary clamping structure. It is for example imaginable that the secondary clamping structure(s) are positioned at or near the corners of the solar panel array and that the primary clamping structure(s) is positioned at a central part of the (double sided) solar panel array. In case the system is applied to a double sided solar panel array, the primary clamping structure(s) can be positioned at a top corner an open side facing edge and/or at the high side of a panel. The distal end of the support arm, if applied, of the primary clamping structure is positioned in a central part such that two wind deflectors can be coupled to the primary clamping structure.

In case the system is applied to a single solar panel array system, the primary clamping structure(s) may preferably be positioned at the side where the solar panel has the highest distance with respect to the roof (or other mounting surface).

In an embodiment, the system may comprise a primary clamping structure as secondary clamping structure. Such an embodiment is in particular advantageous to use for a single sided array of solar panels, also known as south-facing rows or single sided systems.

Configurations of double sided solar panel arrays are also known as east-west systems, or dual systems.

In a preferred embodiment of the primary and/or secondary clamping structure, at least one support arm is integrally connected to at least one connector and/or to at least aligning member. Hence, it is imaginable that at least one support arm forms an integral part of at least one aligning member. It is also possible that at least one support arm forms an integral part of at least one connector. In such embodiment, the support arm and the connector or aligning member can be made of a single piece. In yet another embodiment, it is possible that at least one connector and at least one aligning member are integrally formed.

The system can be made of several suitable materials or combination thereof. It is for example possible that at least part of at least one primary clamping structure and/or at least part of at least one secondary clamping structure is made of metal and/or plastic. Non-limiting examples of metals which could be applied are steel, aluminium and/or variants thereof. Hence, it is imaginable that at least part of at least one primary clamping structure and/or at least part of at least one secondary clamping structure comprises metal, in particular steel and/or aluminium. It is also imaginable that at least part of at least one primary clamping structure and/or at least part of at least one secondary clamping structure is made of least one polymer. At least one polymer can be a (fiber) reinforced polymer. At least part of at least one primary clamping structure and/or at least part of at least one secondary clamping structure can for example be made via injection moulding, casting and/or via die cutting. The primary clamping structure and/or the secondary clamping structure can be substantially rigid. Preferably, at least part of at least one aligning member, at least one connector and/or at least one support arm is substantially rigid. It is also imaginable that at least part of the aligning member, the connector and/or the support arm comprises at least one reinforcing rib. However, it is also imaginable that parts of the primary clamping structure and/or the secondary clamping structure are substantially flexible. It is for example imaginable that at least part of the support arm is substantially flexible for providing flexible support for part of the wind deflector.

In a preferred embodiment, the system according to the present invention comprises at least one wind deflector. It is also imaginable that the system comprises multiple wind deflectors, primary clamping structures and/or secondary clamping structures. At least one wind deflector is preferably designed for providing a protective function for a solar panel mounting system. The wind deflector can for example be substantially elongated. It is also imaginable that at least part of the wind deflector is substantially flat shaped and/or at least partially curved. Typically part of the wind deflector defines part of a triangle. The wind deflector preferably comprises two opposing side edges wherein a primary side edge is larger than the opposing secondary side edge. The primary clamping structure is preferably configured to clampingly connect near the primary side edge and the secondary clamping structure is preferably configured to connect near the secondary side edge. At least one wind deflector can for example comprise folded and/or curved edges. It is imaginable that at least part of at least one wind deflector comprises an edge structure. This could positively contribute to the co-action between the wind deflector and the primary and/or secondary clamping structure(s). Part of the (edge structure of the) wind deflector could for example be configured to be hooked behind part of the aligning member, in particular the wall part of the aligning member. The edge structure of the wind deflector could basically form a receiving space for receiving a top edge of the aligning member in an assembled configuration (wherein the aligning member is attached to a solar panel). The edge structure may form a hook for hooking behind a part of an aligning member, in particular a wall part of the aligning member. It is imaginable that at least one wind deflector comprises one or more apertures for example for receiving parts of mechanical fixing elements. At least one wind deflector can for example be at least partially made of metal and/or plastic. It is for example possible that at least one wind deflector comprises steel. At least one aligning member is preferably configured to be connected with an upper part of the wind deflector. It is imaginable that the aligning member and the wind deflector are connected or connectable via at least fixing element such as a screw. The wind deflector could also be referred to as a wind shield. The wind deflector could also have an aesthetic function. The wind deflector can be a decorative skirt. For example as a decorative skirt (in particular on steep slope roofs), on the bottom or side of an array of solar panels. For this type of application it is conceivable that two secondary clamping structures are used. At least part of the wind deflector is preferably made from a material which emit heat while allowing passive cooling of the solar panels.

The invention also relates to a primary clamping structure according to the present invention. The invention further relates to a secondary clamping structure according to the present invention. Any of the described embodiments for the clamping structured could be included.

The invention further relates to a solar panel array assembly comprising:
an array solar panels, in particular substantially levelled and/or low slope mounted and/or double-sided positioned; and
at least one system according to any of the preceding claims, comprising
   at least one, preferably one, primary clamping structure;
   at least one, preferably three, secondary clamping structures;
   at least one, preferably two, wind deflectors, wherein the wind deflectors preferably at least partially overlap.

The invention will be further elucidated by means of the following non-limitative clauses.

1. System for attaching a wind deflector to a solar panel, in particular to a module frame of a solar panel, said system comprising:
optionally at least one primary clamping structure; and/or
at least one secondary clamping structure;
   wherein at least one primary clamping structure and at least one secondary clamping structure are each configured to be clampingly coupled to at least one solar panel, in particular to the module frame of the solar panel, and to be connected to at least part of at least one wind deflector,
   wherein the primary clamping structure comprises:
at least one support arm;
at least one aligning member; and
at least one connector;
   wherein at least one support arm is connected or connectable to at least part of the aligning member and/or at least part of the connector, and wherein the support arm is substantially elongated and wherein a distal end of the support arm is configured to be connected to at least part of the wind deflector; and
   wherein at least one aligning member and at least one connector are configured such that, in an assembled configuration, at least part of the connector encloses at least part of the aligning member and/or at least part of the aligning member encloses at least part of the connector such that at least part of the solar panel, in particular part of the module frame of the solar panel, is clampingly engaged between the aligning member and the connector.

2. System according to clause 1, wherein at least one secondary clamping structure comprises:
at least one secondary aligning member; and
at least one secondary connector;
   wherein at least one secondary aligning member is configured to be connected to a wind deflector; and
   wherein at least one secondary aligning member and at least one secondary connector are configured such that, in an assembled configuration, at least part of the secondary connector encloses at least part of the secondary aligning member such that at least part of the solar panel, in particular part of the module frame of the solar panel, is clampingly engaged between the secondary aligning member and the secondary connector.

3. System according to any of the previous clauses, wherein at least one aligning member comprises at least one aligning surface.

4. System according to any of the previous clauses, wherein at least one connector comprises at least one clamping surface.

5. System according to any of the previous clauses, wherein at least one connector comprises at least one leg, preferably at least two legs, wherein preferably at least one leg comprises at least one clamping surface at its distal end.

6. System according to any of the previous clauses, wherein at least one aligning member and at least one connector form a clamp.

7. System according to any of the previous clauses, wherein at least one connector comprises at least one receiving space for receiving at least part of a solar panel, in particular at least part of a module frame of the solar panel, and/or for receiving at least part of at least one aligning member.

8. System according to any of the previous clauses, wherein at least one aligning member and/or at least one connector are mutually connectable by means of at least one fixing element.

9. System according to any of the previous clauses, wherein at least one aligning member comprises at least one alignment leg.

10. System according to any of the previous clauses, wherein the aligning member comprises at least one wall part that is configured to abut at least part of a solar panel, in particular part of a mounting frame of the solar panel, wherein said wall part comprises a chamfered top edge.

11. System according to any of the previous clauses, wherein at least one support arm comprises at least one grip element for increasing grip with at least part of a solar panel, in particular at least part of a module frame of the solar panel.

12. System according to any of the previous clauses, wherein at least one support arm comprises at least one clamping element for clampingly engaging at least part of a solar panel, in particular part of a module frame of the solar panel.

13. System according to clause 12, wherein at least one clamping element comprises at least one upper flange part and at least one lower flange part configured to mutually enclose part of the solar panel, in particular part of the module frame of the solar panel.

14. System according to clause 12 or 13, wherein at least one clamping element comprises at least one clamping finger.

15. System according to any of the previous claims, wherein at least one support arm is integrally connected to at least one connector and/or to at least one aligning member.

16. System according to any of the previous clauses, wherein at least part of at least one primary clamping structure and/or at least part of at least one secondary clamping structure is made of metal and/or plastic.

17. System according to any of the previous clauses, wherein at least part of at least one aligning member, at least one connector and/or at least one support arm is substantially rigid.

18. System according to any of the previous clauses, comprising at least one wind deflector.

19. System according to clause 18, wherein at least one wind deflector comprises an edge structure for cooperation with at least part of the at least one aligning member.

20. Primary clamping structure for use in a system according to any of the previous clauses.

21. Primary clamping structure configured for attaching a wind deflector to a solar panel, in particular to a module frame of a solar panel, wherein the primary clamping structure comprises:
at least one support arm;
at least one aligning member; and
at least one connector;
   wherein at least one support arm is connected or connectable to at least part of the aligning member and/or at least part of the connector, and wherein the support arm is substantially elongated and wherein a distal end of the support arm is configured to be connected to at least part of the wind deflector; and
   wherein at least one aligning member and at least one connector are configured such that, in an assembled configuration, at least part of the connector encloses at least part of the aligning member and/or at least part of the aligning member encloses at least part of the connector such that at least part of the solar panel, in particular part of the module frame of the solar panel, is clampingly engaged between the aligning member and the connector.

22. Secondary clamping structure for use in a system according to any of clauses 1 to 19.

23. Secondary clamping structure configured to be clampingly coupled to at least one solar panel, in particular to the module frame of the solar panel, and to be connected to at least part of at least one wind deflector, wherein the secondary clamping structure comprises:
at least one secondary aligning member; and
at least one secondary connector;
   wherein at least one secondary aligning member is configured to be connected to a wind deflector; and
   wherein at least one secondary aligning member and at least one secondary connector are configured such that, in an assembled configuration, at least part of the secondary connector encloses at least part of the secondary aligning member such that at least part of the solar panel, in particular part of the module frame of the solar panel, is clampingly engaged between the secondary aligning member and the secondary connector.

### BRIEF DESCRIPTION OF THE DRAWINGS

The terms Fig., Figs., Figure, and Figures are used interchangeably in the specification to refer to the corresponding figures in the drawings.

The invention will be further elucidated by means of non-limiting exemplary embodiments illustrated in the following figures, in which:

FIG. 1 shows an exploded view of a system according to the present invention;

FIG. 2 shows an example of a secondary clamping structure according to the present invention;

FIG. 3 shows an example of a primary clamping structure according to the present invention;

FIG. 4a shows a cross section of an embodiment of a connector and an aligning member in a clamping engagement with a module frame of a solar panel wherein the module frame comprises a flange at the edge;

FIG. 4b shows a cross section of the same embodiment as shown in FIG. 4a, but in a clamping engagement with a module frame of a solar panel wherein the module frame does not comprise a flange at the edge; and

FIGS. 5a and 5b show a further embodiment of a (primary) clamping structure according to the present invention;

FIG. 6 shows an alternative embodiment of a (primary) clamping structure according to the present invention;

FIG. 7 shows a second embodiment of a secondary clamping structure according to the present invention;

FIG. 8 shows a cross section of a primary clamping structure in an assembly with a wind deflector;

FIG. 9 shows a cross section of a second embodiment of a primary clamping structure in an assembly with a wind deflector;

FIG. 10 shows a cross section of a third embodiment primary clamping structure in an assembly with a wind deflector;

FIGS. 11a-11d show a further possible embodiment of a (secondary) clamping structure according to the present invention; and

FIGS. 12a and 12b show a further possible embodiment of a system 1 according to the present invention.

### DESCRIPTION OF THE INVENTION

Within these figures, similar reference numbers correspond to similar or equivalent elements or features.

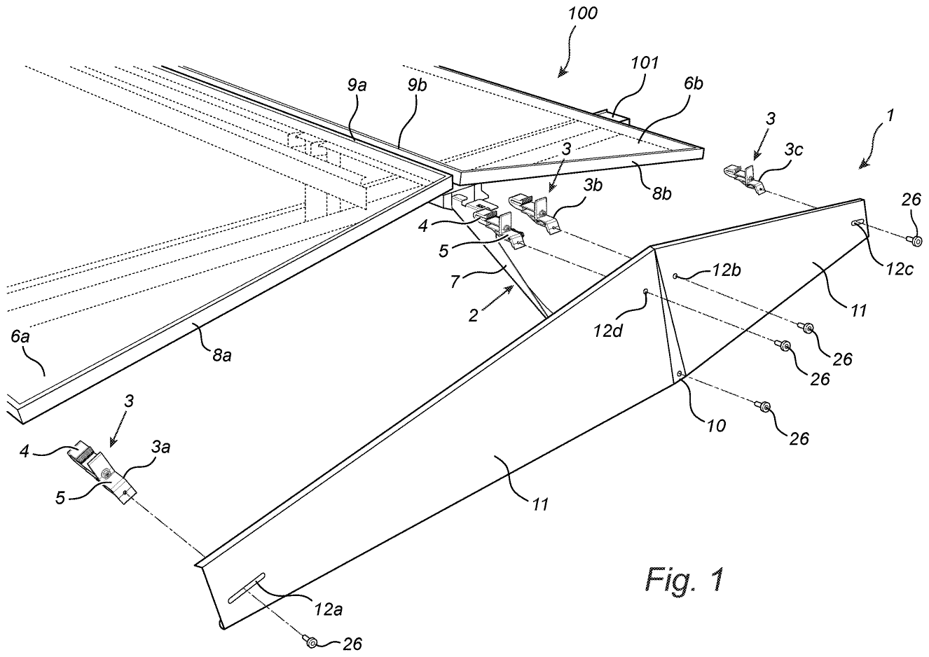

FIG. 1 shows an exploded view of a system 1 according to the present invention. The shown system 1 is applied in combination with a low slope mounted double sided solar array 100. The system 1 as shown comprises a primary clamping structure 2 and multiple secondary clamping structures 3a, 3b, 3c. The primary clamping structure 2 and the secondary clamping structures 3 are configured to be clampingly coupled to at least one solar panel 6a, 6b, in particular to the module frame 8a, 8b of the solar panel 6a, 6b, and to be connected to at the wind deflectors 11. The primary clamping structure 2 and each secondary clamping structure 3 are in particular configured to be clampingly coupled to the solar panels 6a, 6b. The secondary clamping structure 3a can clampingly be coupled with panel 6a on the side edge 8a of the solar panel 6a. In this embodiment, the side edge 8a is formed by the module frame 8a of the solar panel 6a. The primary clamping structure 2 is coupled to the (flange of) edge of the high side 9a and to the side edge 8a of the solar panel 6a. In this exemplary embodiment, the primary clamping structure 2 is coupled to the flange of the (flange of the) edge of the high side 9a of the module frame of the solar panel 6a. The primary clamping structure 2 is further configured to be connected to a lower part of the wind deflector 11 at the coupling region thereof 10. The coupling region 10 of the wind deflector(s) 11 comprises an opening for receiving part of a fixing element. At least one fixing element can fixate the wind deflectors 11 to the distal end of the support arm 7 of the primary clamping structure 2. In the shown embodiment, two wind deflectors 11 can be coupled to one primary clamping structure 2. The aligning member 5 of the primary clamping structure 2 is connectable to the wind deflector 11 at a connection point 12d. The shown primary clamping structure 2 comprises one support arm 7, a connector 4 and an aligning member 5. The wind deflectors 11 can be fixated by the use of fixing elements 26, such as screws 26.

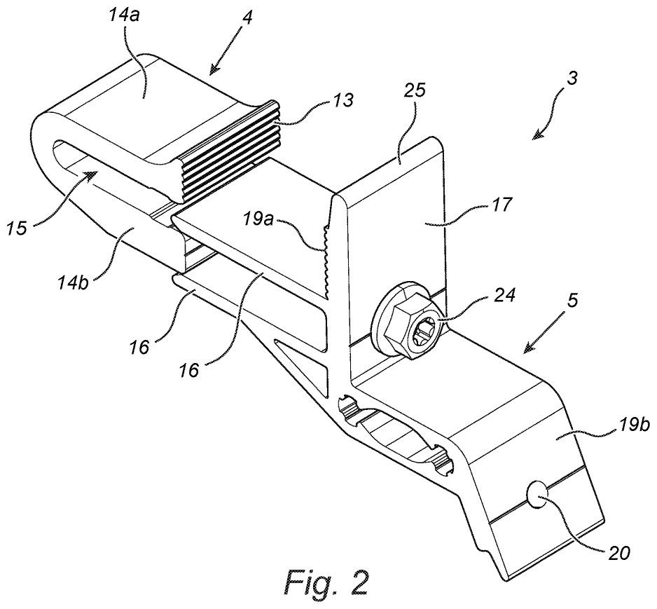

The secondary clamping structures 3, as shown, comprise a (secondary) connector 4 and a (secondary) aligning member 5. The secondary connector 4 and secondary aligning member 5 of the shown embodiment are substantially identical to the connector 4 and aligning member 5 of the primary clamping structure 2. This is shown in more detail in FIG. 2. In the shown embodiment, the support arm 7 of the primary clamping structure 2 is connected to the aligning member 5. The support arm 7 is substantially elongated and forms-in an assembled configuration-a bridge between the solar panel 6a and the wind deflector 11, in particular between the highest edge of the module frame 9a of the solar panel 6a and the connection region 10 of the wind deflector 11. The wind deflectors 11 of the present embodiment partly overlap such that two wind deflectors 11 can be connected at the connection region 10 to the distal end of the support arm 7 of the primary clamping structure 2. The secondary clamping structures 3a, 3b, 3c are configured to be connected to the wind deflector 11 at their indicated positions. The wind deflectors 11 comprise thereto slotted holes 12a, 12c for the connection points with the secondary clamping structures 3a and 3c respectively. This provides for an easy assembly of the wind deflectors 11 and can deal with different dimensions of different types of solar panels, while the same wind deflectors 11 can be used. The connector 4 of the primary and secondary clamping structures 2, 3 as shown is substantially U-shaped. The connector 4 is configured to enclose at least part of the aligning member 5 in an assembled configuration such that part of the module frame 8a, 8b of the solar panels 6a, 6b, is clampingly engaged between each assembly of an aligning member 5 and a connector 4.

As shown in FIG. 1 the system according to the present invention is suitable to be coupled to the open side of a solar array 100. The primary and secondary clamping structures 2, 3a, 3b, 3c are coupled to the solar panels directly and not to the mounting structure 101 which provides support for the solar panels. The mounting structure 101 is positioned at a distance from the edges 8a, 8b of the solar array 100. The system 1 according to the invention is also suitable for a single sided flat mounted solar array. In such a situation only one wind deflector 11 is needed that is mounted to the solar panels, or preferably the module frame of the solar panels, by a connection formed by one primary clamping structure 2 and one secondary clamping structure 3a.

FIG. 2 shows a perspective view of a possible embodiment of a (secondary) clamping structure 3. The figure shows in particular a possible embodiment of a connector 4 and an aligning member 5 that is used as a secondary clamping structure 3 in the embodiment of the system shown in FIG. 1. The embodiment of the clamping structure 3 as shown comprises a substantially U-shaped connector 4. The connector 4 comprises two legs 14a, 14b. The legs 14a, 14b are positioned in a substantially parallel orientation. At the distal end of the upper leg 14a, a clamping surface 13 is provided. The clamping surface 13 of the shown embodiment is a profiled surface 13 comprising several ribs for increased grip on the side edge of a solar panel, in particular to the side edge of the module frame of the solar panel. The connector 4 further comprises a receiving space 15 for receiving part of the aligning member 5. The aligning member 5 comprises alignment legs 16 and a wall part 17. The upper alignment leg 16 and the wall part 17 mutually enclose a substantially 90 degree angle. The receiving space 15 of the connector 4 is configured to receive the upper alignment leg 16 and optionally a flange from a side edge of a module of a solar panel. The wall part 17 comprises a (profiled) aligning surface 19a. The aligning surface 19a is faced towards the module frame of a solar panel during use. The receiving space 15 of the connector 4 may comprise internal screw thread for fixating of the aligning element 5 with the connector 4 by the fixing element 24. In this embodiment the lower leg 14b of the connector 4 comprises inner screw thread for co-action with a screw 24. The fixing element 24 as shown is a screw 24. By turning the screw 24, the connector 4 and aligning member 5 will be moved further towards each other. The profiled clamping surface 13 of the connector 4 and the profiled aligning surface 19a of the aligning member 5 will grip on opposite sides of a side edge of a module frame of a solar panel and thus apply a clamping force on the module frame during use. The connector 4 and aligning member 5 thereby together form a clamp. The clamping structure 3, and in particular the aligning member 5, further comprises a further aligning surface 19b for aligning part of the wind deflector with respect to the solar panel. The aligning member 5, and in particular the further aligning surface 19b, comprises an opening 20 for receiving part of a fixing member. In the shown embodiment, the wall part 17 of the aligning member 5 has a rounded top edge 25. The wall part 17 extends under an angle with respect to the further aligning surface 19b.

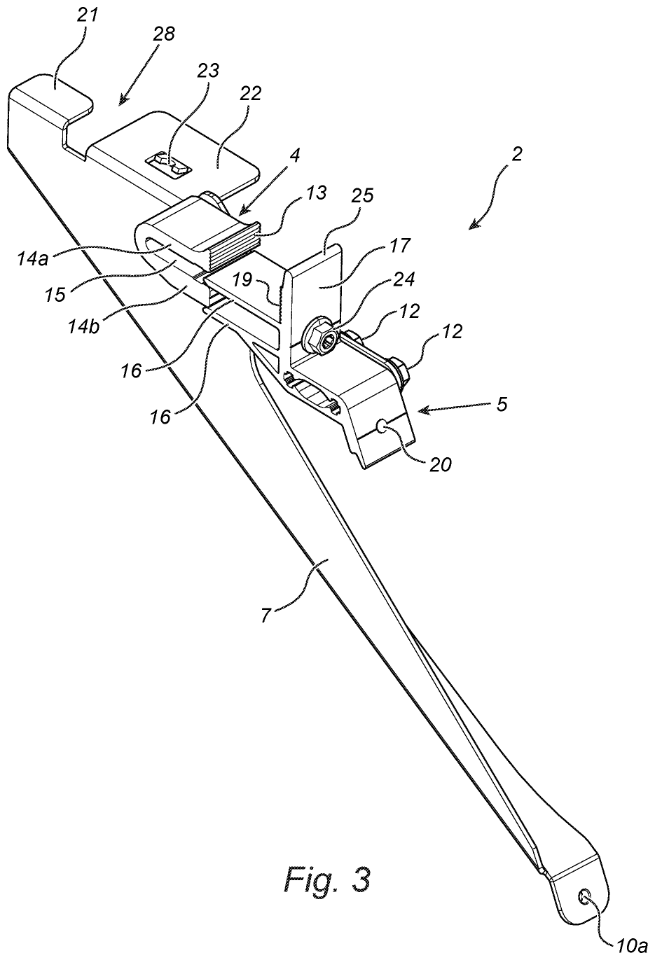

FIG. 3 shows a perspective view of a possible embodiment of a primary clamping 2 structure according to the present invention. In this embodiment the connector 4 and the aligning member 5 are substantially identical to the connector 4 and aligning member 5 of the secondary clamping structure as shown in FIG. 2. These elements thus comprise the same features as described under FIG. 2. The primary clamping structure 2 further comprises a support arm 7 for supporting at least part of a wind deflector. The distal end of support arm 7 comprises a connection surface with through hole 10a configured for receiving part of a fixing element, such as a screw, for fixating a wind deflector to the support arm 7. The through hole 10a can be an aperture and/or a threaded hole. The support arm 7 further comprises a clamping element 28 for clampingly engaging at least part of a solar panel, in particular part of a module frame of the solar panel. The clamping element 28 comprises an upper flange part 21 and a lower flange part 22 configured to mutually enclose and/or clampingly engage part of a side flange of a module frame of the solar panel. There is a vertical and horizontal distance between upper flange part 21 and the lower flange part 22 to facilitate positioning of the module frame in between said flange parts 21, 22. The upper flange part 21 and/or lower flange parts 22 could also be referred to as a clamping fingers 21, 22. Part of the clamping element 28 comprises a grip element 23. This grip element 23 is configured to increase grip on the flange of a bottom surface of a module frame of a solar panel. Clamping finger 21 can additionally or alternately include a grip element 23. The support arm 7 can be coupled to a wind deflector by use of a fixing element at the through hole 10a provided in a surface at the distal end of the support arm 7. In the shown embodiment, the support arm 7 is connected to the aligning member 5 via screws 12. The aligning member 5 comprises accommodating spaces for received part of the screws 12. In line with the embodiment as shown in FIG. 2, the connector 4 comprises two legs 14a, 14b, a clamping surface 13 and a receiving space 15 for receiving part of the aligning member 5. The aligning member 5 comprises alignment legs 16 and a wall part 17 and multiple aligning surfaces 19a, 19b.

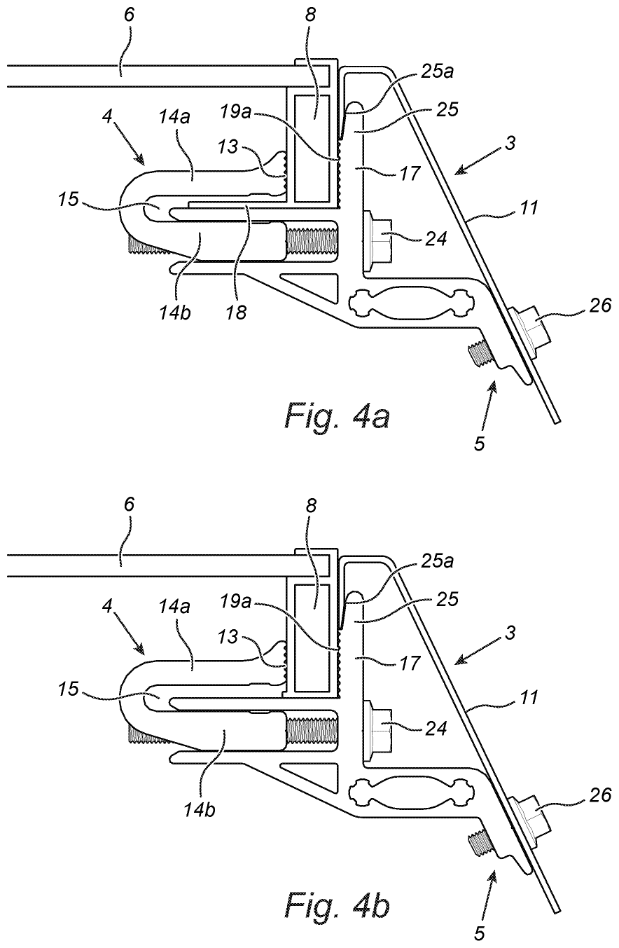

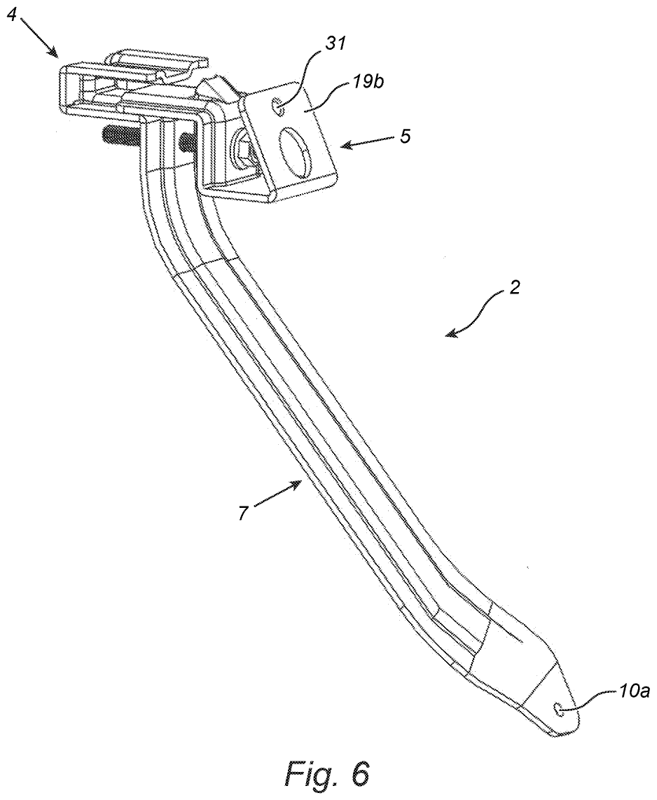

FIGS. 4a and 4b show a (secondary) clamping structure 3 in use for two different types of solar panels 6. Where the solar panel 6 of FIG. 4a comprises a flanged edge, the solar panel 6 of FIG. 6b does not have a flange. FIG. 4a shows a schematic view of a cross section of the clamping structure 3. In the shown configuration, the connector 4 and the aligning member 5 are in a clamping engagement with a side edge 8 of the module frame of the solar panel 6. The module frame 8 comprises a flange 18 at the edge. FIG. 4b shows a cross section of the embodiment of the clamping structure 3 as shown in FIG. 4a, but in a clamping engagement with the edge 8 of a module frame of a solar panel 6 wherein the module frame does not comprise a flange at its edge. In both embodiments as shown the clamping structure 3 is clampingly coupled to the solar panel 6. In FIGS. 4a and 4b a cross section is shown which shows that the chamfered top edge 25 of the aligning member 5, and in particular of the wall part 17 thereof, shows a space 25a in between the side edge 8 of the solar panel 6 and the wall part 17 of the aligning member 5. This space 25a can be used for a profiled, for example curved, top edge of a wind deflector. In an alternative embodiment the aligning member may comprise a wall including a receiving space for receiving a part of a wind deflector. For example, this can be a recessed channel in the top surface of the wall of the aligning member. The top edge of the wind deflector can be hooked behind the top edge 25 of the wall part 17 of the aligning member 5. The alignment surface 19a of the aligning member 5 and the clamping surface 13 of the connector 4 are in abutting contact with opposite sides of the side edge 8 of the module frame of the solar panel 6. The screw 24 fixated the connection between the connector 4 and aligning member 5. Whilst a secondary clamping structure 3 is shown, the teaching also applies to the primary clamping structure according to the present invention. The secondary clamping structure 3 could also form (integral) part of such primary clamping structure. In the cross section shown, a connection of the clamping structure with the wind deflector 11 is shown. A screw is used as a fixing element 26 for connection between the wind deflector and the aligning member 5. The wind deflector 11 comprises a curved edge that hooks behind the chamfered top edge in the receiving space 25a.

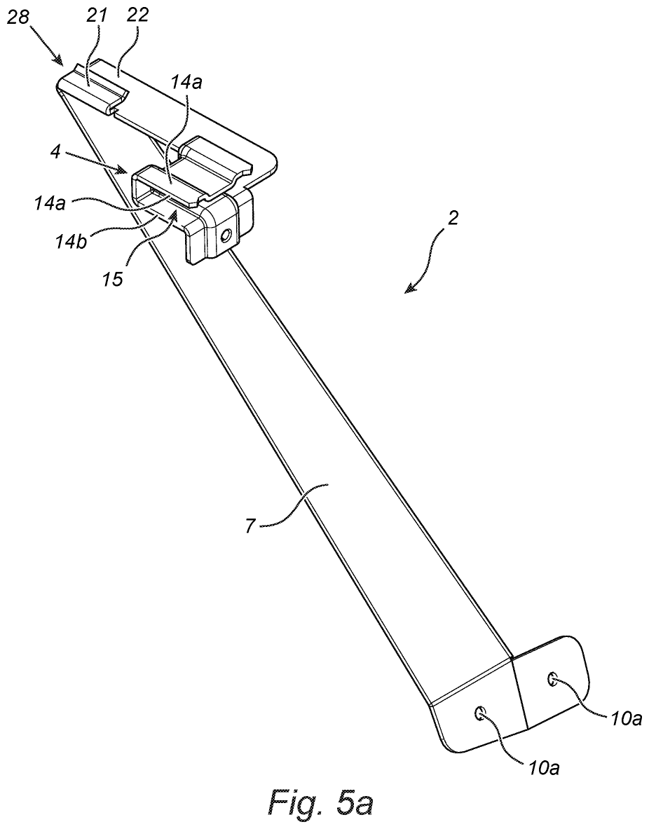

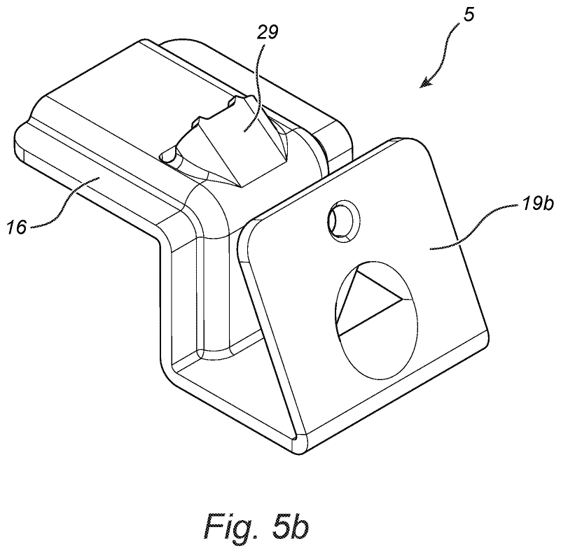

FIGS. 5a and 5b show another embodiment of a (primary) clamping structure 2 according to the present invention. In FIG. 5a part of the primary clamping structure 2 is shown, wherein the connector 4 is integrated with the support arm 7. The distal end of the support arm 7 comprises two through holes 10a configured for a connection with a wind deflector by means of a fixing element. The through holes 10a can be apertures and/or threaded holes for example. FIG. 5b shows the complementary aligning member 5. The receiving space 15 from the connector 4 shown in FIG. 5a is configured to receive the alignment leg 16 of the aligning member 5 shown in FIG. 5b. By a fixing element such as a screw both the aligning member 5 and the connector 4 can be mutually displaced and fixation, in particular such that the aligning member 5 and the connector 4 form a clamp. The connector 4 comprises two legs 14a, 14b. The legs 14a, 14b are positioned in a substantially parallel orientation. The primary clamping structure 2, and in particular the support arm 7, further comprises a clamping element 28 comprising a clamping finger 21 and an integrated (second) clamping finger 22. The aligning member 5 further comprises a further aligning surface 19b for aligning part of the wind deflector with respect to the solar panel. The aligning member 5 comprises a grip element 29 for increasing grip with at least part of a solar panel and/or the connector 4. The grip element 29 is positioned on an aligning surface 19a. The embodiment as shown in FIGS. 5a and 5b is in particular made of metal. Preferably the integrated connector 4 and support arm 7 shown in FIG. 5a can be made from a piece of sheet metal. The aligning member 5b can preferably be made out of a piece of sheet metal.

The embodiment shown in FIGS. 5a/5b engages with two sides of the solar panel. The clamping FIGS. 21, 22 clampingly engage on the high side of the module frame of the solar panel and the connector 4 and aligning member 5 engage on the side facing the open side of the solar panel array of the module frame of the solar panel.

FIG. 6 shows an alternative of a primary clamping structure 2. The primary clamping structure 2 shown also comprises an integrated connector 4. The connector 4 is integrated with the support arm 7. The primary clamping structure 2 further comprises an aligning member 5. This embodiment is in particular different from the embodiment shown in FIGS. 5a/5b because the primary clamping structure 2 clampingly engages with one side of the solar panel, instead of two. The distal end of the support arm is configured for connecting with a wind deflector. The aligning surface 19b comprises an aperture, that can be used for access to the screw 24 (fixing element) for clampingly engaging the primary clamping structure 2 to a side of a solar panel. The distal end of the support arm 7 comprises a through hole 10a, for example a threaded hole and/or an aperture, that can receive a fixing element, such as a screw, for fixating or connecting a wind deflector to the primary clamping structure. The wind deflector can be attached to the primary clamping structure in two places, at the distal end of the arm 7 and at through hole 31 in the the aligning surface 19b of the aligning member 5.

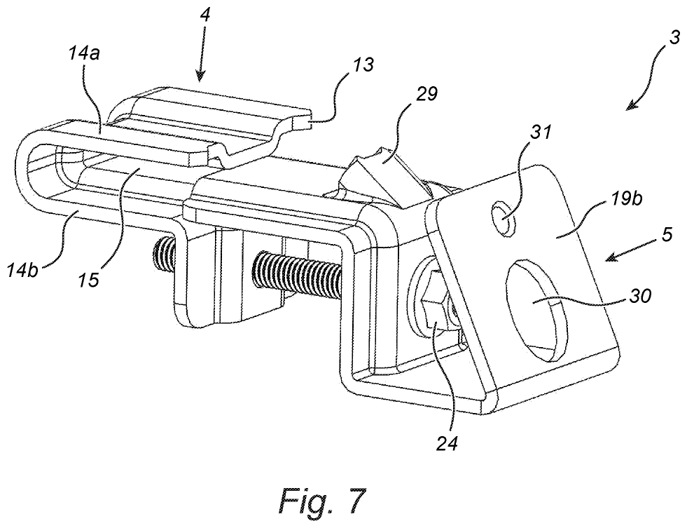

The primary clamping structure shown in FIGS. 5a, 5b and the embodiment shown in FIG. 6 can be combined with any secondary clamping structure according to the present invention forming a system according to the present invention. For example, a secondary clamping structure as shown in the previous figures, especially FIG. 2, can be used. It is also possible to use a secondary clamping structure as shown in FIG. 7. The secondary clamping structure can also be a simple clamp or clip. The parts shown in FIG. 6 are preferably made from sheet metal. The connector 4 and aligning member 5 that are shown in more detail in FIG. 7. In FIG. 7 the connector is shown apart from the support arm 7, but as shown the connector 4 can be integrally formed with the support arm 7.

FIG. 7 shows an alternative embodiment of a secondary clamping structure 3 comprising a connector 4 and an aligning member 5. The connector 4 and aligning member 5 are configured to clampingly engage a module frame of a solar panel or a side of a solar panel in between the grip element 29 and the surface 13. The connector encloses the leg of the aligning member 5. The alignment leg 16 of the aligning member 5 is received in the receiving space 15 that is formed by the legs 14a and 14b of the connector 4. The aligning member 5 comprises an alignment surface 19b. Said alignment surface aligns the wind deflector (not shown). The alignment surface 19b comprises an aperture 30 through which the screw 24 can be reached. By applying a force on the screw the connector 4 and aligning member 5 are moved towards each other in order to clampingly engage with a side of a solar panel and/or with a side of a module frame of a solar panel. The aligning member 5 further comprises a through hole 31 for receiving a fixing element for fixating (connecting) a wind deflector to the secondary clamping element 3.

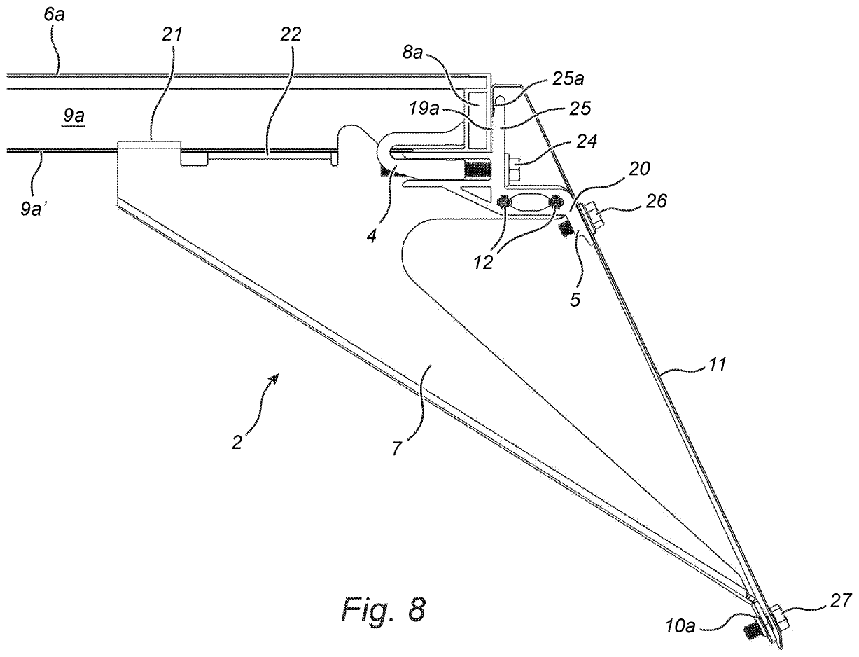

FIGS. 8, 9 and 10 show cross sections of different embodiments of primary clamping structures 2 in an assembled state. Each primary clamping structure 2 is clampingly engaged with the module frame of the solar panel shown and attached to a wind deflector 11. The figures are views of a cross section taken through the support arm 7 of the respective primary clamping structures 2.

FIG. 8 shows a cross section of a primary clamping structure 2 in an assembly with a wind deflector 11 and an edge 8a of a module frame of a solar panel 6a. The primary clamping structure 2 clampingly engages with side edges 8 and the flange 9a′ of side edge 9a of the module frame. It is conceivable that the support arm would engage with the entire module frame and not the flange. The embodiment shown corresponds to the primary clamping structure as shown in FIG. 3. Therefore, similar reference numbers are used to indicate similar features. The aligning member 5 is connected by screws 12 to the support arm 7 of the primary clamping structure 2. The wind deflector 11 is mounted to the aligning member 5 with a screw 26 and to the distal end of the support arm by screw 27.

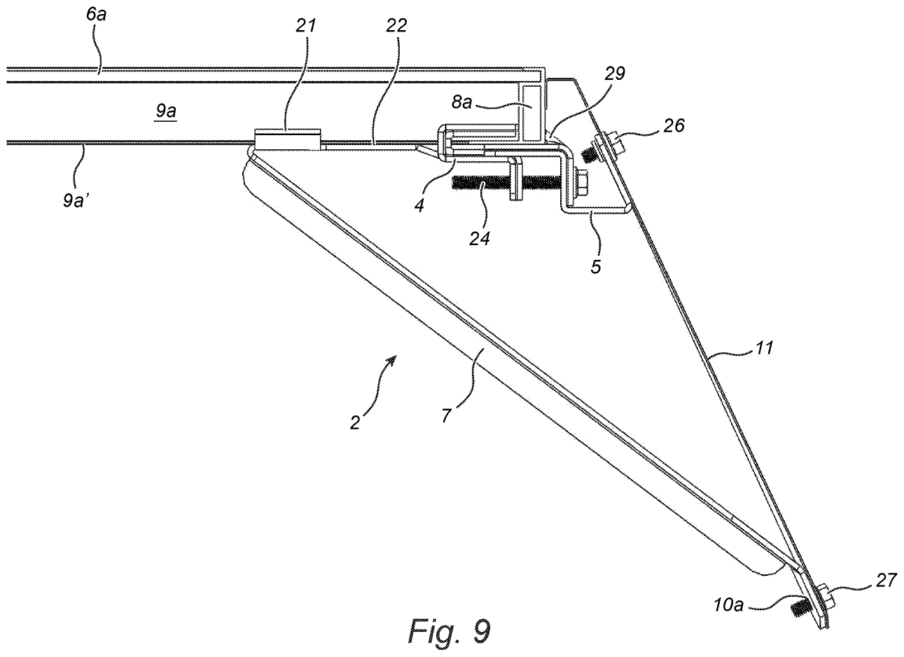

FIG. 9 shows a cross section of a second embodiment of a primary clamping structure in an assembly with a wind deflector 11 and an edge 8a of a module frame of a solar panel 6a. The primary clamping structure 2 clampingly engages with side edges 8 and the flange 9a′ of side edge 9a of the module frame. It is conceivable that the support arm would engage with the entire module frame and not the flange. The embodiment shown corresponds to the embodiment of the primary clamping structure as shown in FIGS. 5a and 5b. Therefore, similar reference numbers are used to indicate similar features. The wind deflector 11 is mounted to the aligning member 5 with a screw 26 and to the distal end of the support arm by a screw 27.

It's conceivable that the alignment member 5 the connector 4 and the support arm 7 are integrally formed. Preferably such an integrally formed alignment member, connector and support arm are made from sheet metal. The wind deflector 11 can be used as a clamping element or locking element to prevent the (primary) clamping structure from separating or disengaging from the solar panel and/or the module frame of the solar panel.

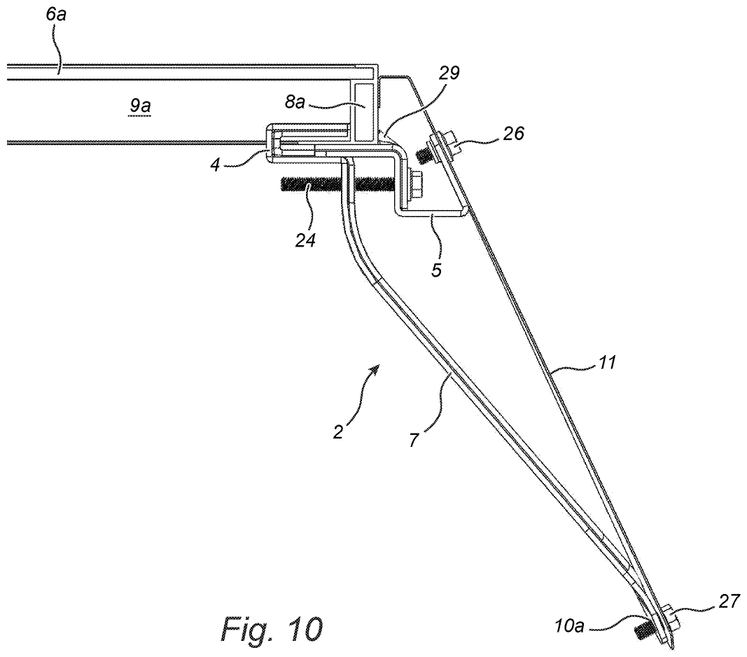

FIG. 10 shows a cross section of a third embodiment primary clamping structure in an assembly with a wind deflector 11 and an edge 8a of a module frame of a solar panel 6a. The embodiment shown corresponds to the embodiment of the primary clamping structure as shown in FIG. 6. Therefore, similar reference numbers are used to indicate similar features. The wind deflector 11 is mounted to the aligning member 5 with a screw 26 and to the distal end of the support arm by a screw 27.

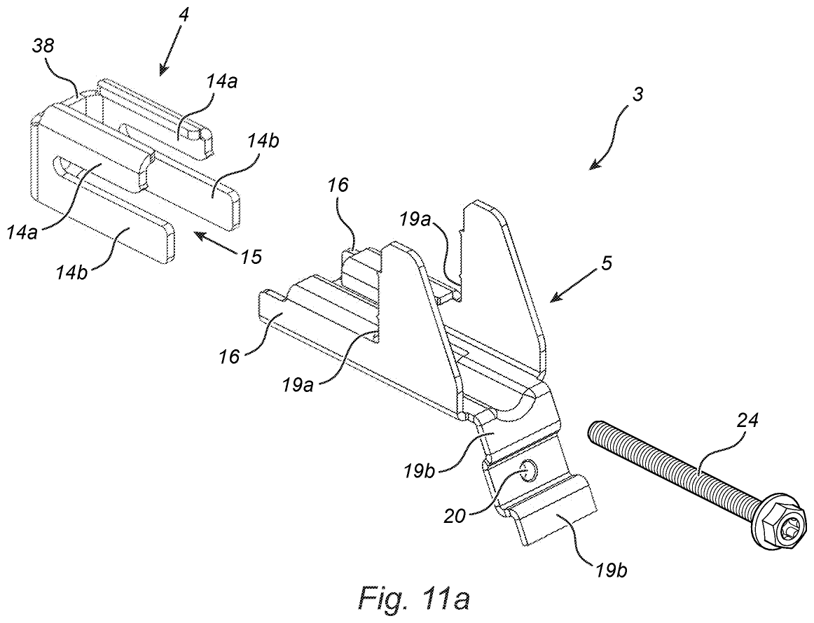

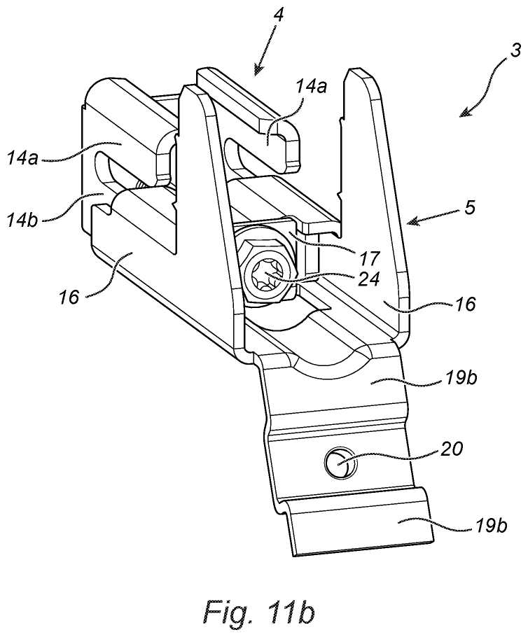

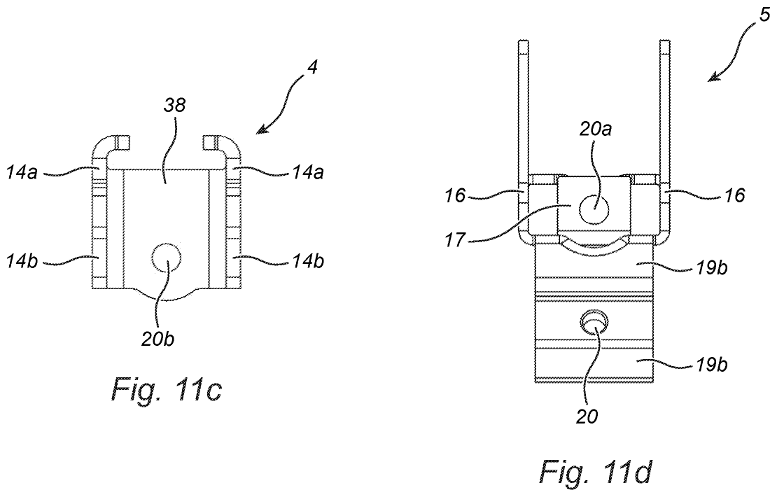

FIG. 11a shows a perspective and exploded view of a further possible embodiment of a (secondary) clamping structure 3 according to the present invention. FIG. 11b shows the same clamping structure 3 in an assembled configuration. The figures show in particular a possible embodiment of a connector 4 and an aligning member 5 that can be used as a secondary clamping structure 3 a system according to the present invention. FIGS. 11c and 11d show cross sectional views of respectively the connector 4 and the aligning member 5.

The clamping structure 3 and connector 4 of the shown embodiment can be mutually attached via a fixing element 24, which is in the shown embodiment formed by a screw 24. The connector 4 comprises multiple legs 14a, 14b. More in particular, the connector 4 comprises multiple upper legs 14a and multiple lower legs 14b. It could also be said that the upper leg 14a and the lower leg 14b comprises multiple leg parts. The lower and/or upper legs 14a, 14b are positioned in a substantially parallel orientation. The connector 4 comprises, or defines, a receiving space 15 for receiving part of the aligning member 5. The aligning member 5 comprises alignment legs 16 and a wall part 17. The upper alignment leg 16 and the wall part 17 mutually enclose a substantially 90 degree angle. The receiving space 15 of the connector 4 is configured to receive part of an alignment leg 16 and optionally a flange from a side edge of a module of a solar panel. The wall part 17 comprises an opening 20a for the fixing element 24. The opening 20a may comprise (internal) screw thread. The aligning member 5 comprises at least one aligning surface 19a. The receiving space 15 of the connector 4 may comprise internal screw thread for fixating of the aligning element 5 with the connector 4 by the fixing element 24. In this embodiment a back part 38 of the connector 4 comprises an opening 20b preferably comprising an inner screw thread for co-action with a screw 24. By turning the screw 24, the connector 4 and aligning member 5 will be moved further towards each other such that the connector 4 and the aligning member 5 will grip on opposite sides of a side edge of a module frame of a solar panel and thus apply a clamping force on the module frame during use. The connector 4 and aligning member 5 thereby together form a clamp. The clamping structure 3, and in particular the aligning member 5, further comprises a further aligning surface 19b for aligning part of the wind deflector with respect to the solar panel. The aligning member 5 further comprises an opening 20 for receiving part of a fixing member.

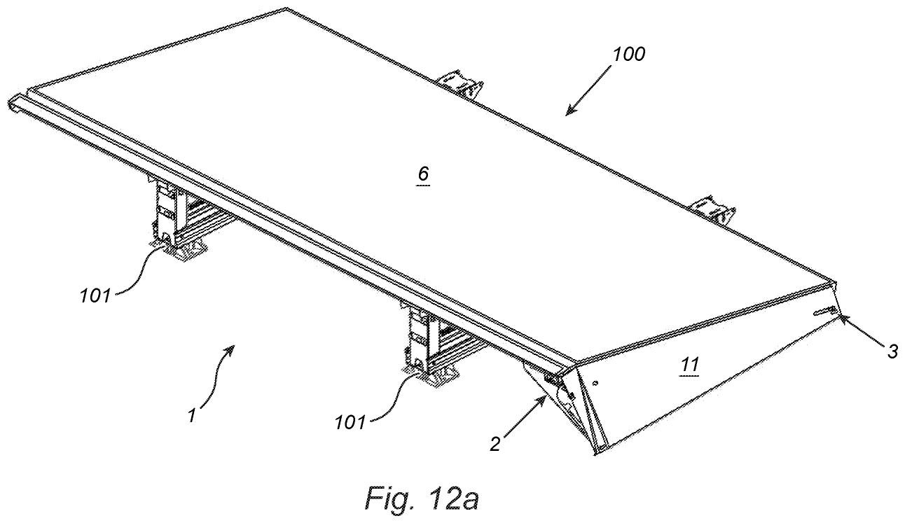

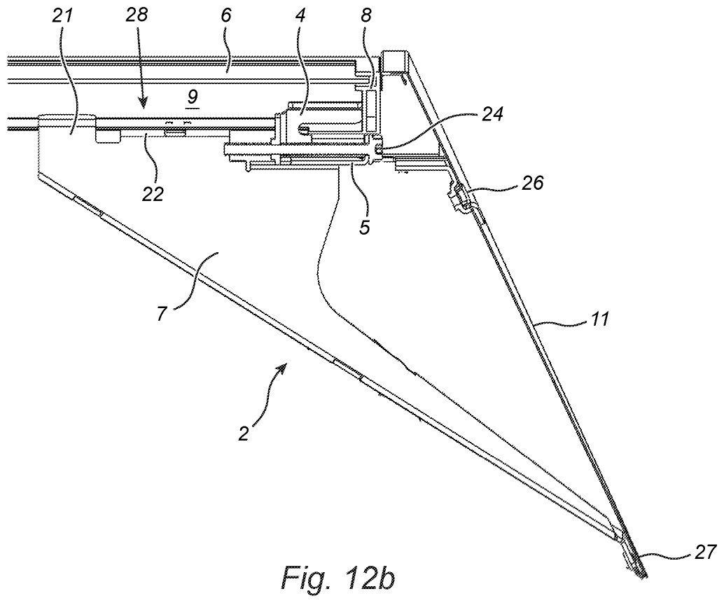

FIGS. 12a and 12b show a further possible embodiment of a system 1 according to the present invention. FIG. 12a shows a perspective view of part of the system 1. FIG. 12b shows a cross sectional view of system 1 in an assembled state. The system 1 is configured to be applied in combination with a solar panel array 100, in particular a low slope mounted double sided solar array 100. The part of the system 1 as shown comprises a primary clamping structure 2 and a secondary clamping structure 3. The primary clamping structure 2 and the secondary clamping structure 3 are configured to be clampingly coupled to at least one solar panel 6, in particular to the module frame of the solar panel 6, and to at least one wind deflectors 11. The primary clamping structure 2 and the secondary clamping structure 3 are in particular configured to be clampingly coupled to the solar panel 6.

As can be seen in FIGS. 12a and 12b, the system 1 according to the present invention is suitable to be coupled to the open side of a solar array 100. The primary and secondary clamping structures 2, 3 are coupled to the solar panels 6 directly and not to the mounting structure 101 which provides support for the solar panels. The mounting structure 101 is positioned at a distance from the edges of the solar array 100. The primary clamping structure 2 is clampingly engaged to the module frame 8 of the solar panel 6 shown and attached to a wind deflector 11. FIG. 12b shows in particular a cross section taken through the support arm 7 of the primary clamping structure 2. The primary clamping structure 2 clampingly engages with side edges 8 and the flange 9 of side edge of the module frame. It is conceivable that the support arm 7 would engage with the entire module frame and not the flange. The embodiment shown corresponds to the primary clamping structure as shown in FIGS. 11a-11d. The aligning member 5 is connected via screws 12 to the support arm 7 of the primary clamping structure 2. The wind deflector 11 is mounted to the aligning member 5 with a screw 26 and to the distal end of the support arm by a screw 27. The support arm 7 further comprises a clamping element 28 for clampingly engaging at least part of a solar panel, in particular part of a module frame of the solar panel. The clamping element 28 comprises an upper flange part 21 and a lower flange part 22 configured to mutually enclose and/or clampingly engage part of a side flange of a module frame of the solar panel 6. There is a vertical and horizontal distance between upper flange part 21 and the lower flange part 22 to facilitate positioning of the module frame in between said flange parts 21, 22.

Any primary clamping structure shown can be combined with a secondary clamping structure of choice. Preferably, the secondary clamping structure shown in FIG. 2 is used in combination with the primary clamping structure shown in FIG. 3. Other preferred combinations are the primary clamping structure shown in FIGS. 5a/5b or 6 to combine with a secondary clamping structure shown in FIG. 7.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1-21. (canceled)

22. A system for attaching a wind deflector to a solar panel, in particular to a module frame of a solar panel, said system comprising:
at least one primary clamping structure; and
at least one secondary clamping structure;
wherein at least one primary clamping structure and at least one secondary clamping structure are each configured to be clampingly coupled to at least one solar panel, in particular to the module frame of the solar panel, and to be connected to at least part of at least one wind deflector,
wherein the primary clamping structure comprises:
at least one support arm;
at least one aligning member; and
at least one connector;
wherein at least one support arm is connected to at least part of the aligning member and/or at least part of the connector, and wherein the support arm is substantially elongated and wherein a distal end of the support arm is configured to be connected to at least part of the wind deflector; and
wherein at least one aligning member and at least one connector are configured such that, at least part of the solar panel, in particular part of the module frame of the solar panel, is clampingly engaged between the aligning member and the connector.

23. The system according to claim 22, wherein in an assembled configuration, at least part of the connector encloses at least part of the aligning member and/or at least part of the aligning member encloses at least part of the connector.

24. The system according to claim 22, wherein at least one secondary clamping structure comprises:
at least one secondary aligning member; and
at least one secondary connector;
wherein at least one secondary aligning member is configured to be connected to a wind deflector; and
wherein at least one secondary aligning member and at least one secondary connector are configured such that, in an assembled configuration, at least part of the secondary connector encloses at least part of the secondary aligning member such that at least part of the solar panel, in particular part of the module frame of the solar panel, is clampingly engaged between the secondary aligning member and the secondary connector.

25. The system according to claim 22, wherein at least one aligning member comprises at least one aligning surface and/or, wherein at least one aligning member and at least one connector form a clamp.

26. The system according to claim 22, wherein at least one connector comprises at least one clamping surface.

27. The system according to claim 22, wherein at least one connector comprises at least one leg, preferably at least two legs, wherein preferably at least one leg comprises at least one clamping surface at its distal end.

28. The system according to claim 22, wherein at least one connector comprises at least one receiving space for receiving at least part of a solar panel, in particular at least part of a module frame of the solar panel, and/or for receiving at least part of at least one aligning member, and/or,
wherein at least one aligning member and/or at least one connector are mutually connectable by means of at least one fixing element.

29. The system according to claim 22, wherein at least one aligning member comprises at least one alignment leg.

30. The system according to claim 22, wherein the aligning member comprises at least one wall part that is configured to abut at least part of a solar panel, in particular part of a mounting frame of the solar panel, wherein said wall part comprises a chamfered top edge.

31. The system according to claim 22, wherein at least one support arm comprises at least one grip element for increasing grip with at least part of a solar panel, in particular at least part of a module frame of the solar panel.

32. The system according to claim 22, wherein at least one support arm comprises at least one clamping element for clampingly engaging at least part of a solar panel, in particular part of a module frame of the solar panel.

33. The system according to claim 32, wherein at least one clamping element comprises at least one upper flange part and at least one lower flange part configured to mutually enclose part of the solar panel, in particular part of the module frame of the solar panel.

34. The system according to claim 32, wherein at least one clamping element comprises at least one clamping finger.

35. The system according to claim 22, wherein at least one support arm is integrally connected to at least one connector and/or to at least one aligning member.

36. The system according to claim 22, wherein at least part of at least one primary clamping structure and/or at least part of at least one secondary clamping structure is made of metal and/or plastic.

37. The system according to claim 22, wherein at least part of at least one aligning member, at least one connector and/or at least one support arm is substantially rigid.

38. The system according to claim 22, comprising at least one wind deflector.

39. The system according to claim 38, wherein at least one wind deflector comprises an edge structure for cooperation with at least part of the at least one aligning member.

40. A primary clamping structure for use in a system according to claim 22.

41. A secondary clamping structure for use in a system according to claim 22.
